(19) United States
(12) Patent Application Publication
(10) Pub. No.: US 2005/0134180 A1
(43) Pub. Date: Jun. 23, 2005

(54) Discharge lamp

(75) Inventor: Mitsuru Ikeuchi, Himeji-shi (JP)

Correspondence Address: NIXON PEABODY, LLP, 401 9TH STREET, NW, SUITE 900, WASHINGTON, DC, 20004-2128, US

(73) Assignee: Ushiodenki Kabshiki Kaisha, Tokyo (JP)

(21) Appl. No.: 11/006,661

(22) Filed: Dec. 8, 2004

(30) Foreign Application Priority Data
Dec. 17, 2003 (JP) 2003-419299

(51) Int. Cl. H01J 1/02; H01J 17/20; H01J 17/04

(52) U.S. Cl. 313/633; 313/574; 313/491

(57) ABSTRACT

A discharge lamp with high radiance in which constant feed of the emitter to the electrode tip is achieved, in which a good electron emission characteristic is maintained, and which has electrodes by which stable operation over a long time is maintained is obtained in a discharge lamp which has a translucent vessel which is hermetically closed and contains a pair of opposite electrodes that are electrically connected via hermetically sealed areas by at least one of the electrodes being made of a metal with a high melting point that has a hermetically sealed chamber that contains an emitter and a space which is not filled with the emitter.

### BACKGROUND OF THE INVENTION

1. Field of the Invention

The invention relates to a discharge lamp with high radiance, such as a super-high pressure mercury lamp or the like. The invention relates especially to its electrodes.

2. Description of the Prior Art

The electrodes of a discharge lamp with high radiance acquire a good electron emission characteristic in that an emitter, such as thorium, lanthanum, barium or the like, is adsorbed by the substrate material comprising the electrodes, and the work function is reduced. However, since the emitter is vaporized from the electrode surface and is lost, to maintain a good electron emission characteristic it is necessary to add emitter.

It can be imagined that, conventionally, a material with a good electron emission property in the form of an oxide is present within a substrate metal with a high melting point and by diffusion is transported as far as the tip. The feed of the emitter to the electrode tip is therefore reduced since the diffusion path grows longer over time. When the amount of feed from the inside of the electrode is more dramatically reduced than the amount which is lost from the electrode tip, the service life is limited because the arc spot moves, the size of the arc spot changes, and thus the phenomenon of an unstable arc is caused.

If initially the content of emitter within the substrate metal of the electrode is increased, the initial feed amount of the emitter is too large. The emitter which has been supplied in excess immediately vaporizes; this causes attenuation of the irradiance by initial blackening after the start of operation. The method of increasing the content of the emitter and thus of prolonging the service life therefore has its limit.

In Japanese Patents JP 2732451 B2 and JP 2732452 B2, an arrangement is proposed in which, within a cathode, there is a cavity which is filled with a barium-based emitter in order to supply the emitter to the electrode tip over a long time.

In the technology disclosed in these publications, the emitter is supplied to the electrode tip over a longer time than in the technology in which an emitter is uniformly distributed within the substrate metal of the electrode. However, since the phenomenon of diffusion within a solid is used, such as crystal grain boundary diffusion, diffusion in the crystal grain or the like, the added emitter is used up, and moreover, the diffusion path is lengthened. That the amount of feed of the emitter to the electrode tip is reduced over the course of time cannot be avoided.

Japanese patent publication JP-A-HEI 9-92201 proposed the following arrangements for stable operation during operation of an arc lamp with high output power:
an arrangement in which the core and the peripheral area of a metal with a high melting point are impregnated with an emitter and in which the surface is coated with a metal with a high melting point; and
an arrangement in which a porous metal with a high melting point is impregnated with an emitter and in which this impregnated metal is provided with a hollow path with one open end.

In these arrangements, the diffusion path is lengthened over the course of time since the transport of the emitter to the tip takes place by diffusion. Therefore, it is difficult to keep the feed amount constant.

Japanese patent publication JP-A-HEI 11-154488 proposed for stable operation of an arc lamp with high output power, an arrangement in which a cavity and a tip through opening are provided and in which the cavity is filled with an emitter. With respect to transport of the emitter to the electrode tip, the diffusion path to the through opening is the same. However, since the added emitter is being used up and since the path to the electrode tip is being lengthened, it is difficult to keep the feed amount constant.

### SUMMARY OF THE INVENTION

A primary object of the present invention is to devise a discharge lamp with high radiance in which a constant feed of the emitter to the electrode tip is achieved, in which a good electron emission characteristic is maintained, and which has electrodes by which stable operation over a long time is maintained.

According to a first aspect of the invention, in a discharge lamp which has a translucent vessel which is hermetically closed, in which there are a pair of opposed electrodes and in which the electrodes are electrically connected via hermetically sealed areas on the translucent vessel, the above described object is achieved in that, of these electrodes, the electrode which is made of a metal with a high melting point and which is operated as a cathode has in its interior a hermetically closed chamber to which an emitter is added and in which there is a space which is not filled with the emitter.

Since the emitter vaporizes with a high vapor pressure within the hermetically closed chamber and becomes a gas with which the hermetically closed chamber is filled, an adsorption layer is formed on the surface within the hermetically closed chamber which is directly adjacent to the electrode tip. The formation of the adsorption layer on the inner surface of the hermetically closed chamber is described below in the case in which the substrate metal is tungsten and the emitter is cerium. The vapor pressure of the hermetically closed chamber is determined by the temperature of the coolest area in which the liquid or the solid coexists with the gaseous phase within the hermetically closed chamber. When cerium is added to the hermetically closed chamber and the temperature of the coolest area is adjusted to roughly 1900 K, the vapor pressure of cerium reaches roughly 133 Pa. Since the melting point of cerium is 1077 K, the hermetically closed chamber is filled with the liquid and the gas.

The inside wall of the hermetically closed chamber directly adjacent to the electrode tip reaches the highest temperature. When the thickness of the partition between the electrode tip and the hermetically closed chamber is roughly 1 mm, this temperature reaches about 2400 K. Since cerium atoms are often adsorbed by the crystal surfaces of the tungsten and since the energy of adsorption of the cerium atoms on the tungsten crystal surfaces is greater than the energy of mutual cohesion of the cerium atoms, the cerium for the existing cerium vapor of 133 Pa can maintain the adsorption layer up to a high temperature of roughly 3200 K. Thus, the entire surface of the inside wall of the hermetically closed chamber is covered by the adsorption layer of cerium.

When cerium is added to the hermetically closed chamber and the temperature of the coolest area is adjusted to roughly 1700 K, the vapor pressure of cerium reaches roughly 13.3 Pa. The cerium for the existing cerium vapor with 13.3 Pa can maintain the adsorption layer up to a high temperature of roughly 2900 K. In this case, the entire surface of the inside wall of the hermetically closed chamber is also covered by the adsorption layer of cerium.

Generally, since the energy of adsorption on the tungsten crystal surfaces is greater than the energy of mutual cohesion of the atoms of the emitter in the case of an emitter, an adsorption layer is easily formed. For the emitter, it is necessary that, on the tip, an adsorption layer is formed in order to simplify electron emission on the electrode tip. It can be imagined that, at a lower temperature than on the tip, an adsorption layer is formed because the temperature of the tip is adjusted to the temperature at which this adsorption layer can be stably maintained. When the vapor pressure of the emitter within the hermetically closed chamber is sufficient, therefore on the inside wall of the hermetically closed chamber in the invention, an adsorption layer is formed essentially with certainty.

Between directly adjacent to the electrode tip and the tip, the emitter is transported by diffusion as a result of the concentration gradient. However, since for an emitter which is located directly adjacent to the electrode tip at a high vapor pressure an adsorption layer is formed, and since the emitter dissolves up to the solid-soluble boundary of the substrate metal, and furthermore, also penetrates into the crystal grain boundaries, the concentration and the feed amount of the transported emitter per unit of time are kept constant.

Even if during operation of the lamp with electrodes located on top of one another, by the action of the force of gravity, the cohesion phase of the emitter comes into contact with the surface within the hermetically closed chamber which is located directly underneath the electrode tip, the concentration is kept constant directly underneath the electrode tip, since the emitter is dissolved up to the solid-soluble boundary of the substrate metal. In the area from directly underneath the electrode tip to the tip, the feed amount of the emitter is kept constant by diffusion as a result of the concentration gradient. When the cross section of the hermetically closed chamber is small, there is also a case in which, by surface tension, the area directly underneath the electrode tip within the hermetically closed chamber has a gaseous phase, even if the force of gravity is acting. In this case, the concentration is also kept constant by the adsorption layer of the emitter. The feed amount is therefore kept constant. This means that regardless of the operating position of the electrode the feed amount can be kept constant when there is a space within the hermetically closed chamber.

By enclosing an emitter with a high vapor pressure in the hermetically closed chamber, the emitter can be rapidly transported in a large amount to directly adjacent to the electrode tip. Furthermore, the emitter is transported to the electrode tip within the hermetically closed chamber as a result of the fact that the electrode has a higher operating temperature, the nearer the tip is approached, and that the diffusion coefficient is greater, the higher the temperature. Therefore, for a small added amount of the emitter a long service life can be achieved. Furthermore, that unnecessary emitter emerges from the inside of the electrode into the discharge space and fouls the inside of the lamp can be minimized.

The object is also achieved in that emitter which is to be added to the above described hermetically closed chamber contains an element which is selected from scandium, yttrium, lanthanum, cerium, gadolinium, barium and thorium.

These metals act effectively on the surface of a metal with a high melting point, such as tungsten or the like, as an electron emissive material, and moreover, have low reactivity with the tungsten or the like which comprises the material which encloses the hermetically closed chamber. The hermetically closed chamber is therefore not corroded, but can be kept stable. Furthermore, the solubility of these metals in tungsten is relatively low. The concentration in the metal with a high melting point directly adjacent to the electrode tip is therefore determined by the solubility. It can be imagined that this contributes to stabilization of feed of the emitter.

Still further, the object is achieved in that the main component of the substrate metal in the tip area of the electrode is tungsten and that the substrate metal in the tip area of the electrode contains an emitter. Several dozen to several hundred hours are necessary until the emitter within the hermetically closed chamber travels to the electrode tip. Therefore, if the substrate metal does not contain an emitter, the treatment with emitters is necessary beforehand. By the measure that the main component of the substrate metal in the tip area of the electrode is tungsten and that the substrate metal in the tip area of the electrode contains an emitter, by which at the start of operation the electrode works as an electrode of the conventional type, and that before this emitter dries out the emitter is transported from the inside of the hermetically closed chamber to the tip, stable feed of the emitter can be ensured.

Furthermore, in a discharge lamp which has a translucent vessel which is hermetically closed and in which there are opposed electrodes which are electrically connected via sealed areas which are hermetically closed on the translucent vessel, the object is achieved in that, of these electrodes, the electrode which is operated as the cathode is formed of a metal with a high melting point which contains the emitter, that within the electrode there is a hermetically closed chamber which is kept hermetically closed, that an inductive material which induces the emitter from the substrate is added to the hermetically closed chamber and that in this hermetically closed chamber there is a space which is not filled with the inductive material.

If, within the hermetically closed chamber, there is a material which reduces emitter oxide, and which induces the emitter into the hermetically closed chamber, this reduction takes place in the area in the vicinity of the inside surface of the hermetically closed chamber, by which a metal with a higher vapor pressure than the oxide is obtained and is routed into the hermetically closed chamber.

In the case, for example, of tungsten which contains La₂O₃ (oxide of lanthanum) as the emitter, by adding, for example, calcium as the inductive material, La₂O₃ in the vicinity of the inside surface of the hermetically closed chamber is reduced at a high temperature. Metallic lanthanum is formed with a high vapor pressure. The inside of the hermetically closed chamber is filled with vapor. Thus, the same action as when adding the emitter as a metal to the hermetically closed chamber can be caused.

In the case in which the inductive material, i.e., the reducing substance, is carbon, together with lanthanum, carbon monoxide is produced. It can be imagined that it is dissociated again in the substrate metal into carbon and oxygen and is dissolved in tungsten. Since the diffusion coefficient of oxygen in tungsten is large, the oxygen is emitted from the electrode.

Additionally, the object is achieved in that the above described inductive material is selected from a material which contains an element which is selected from calcium, magnesium, strontium, zirconium, hafnium and carbon. These elements are effective as inductive material, and moreover, have low reactivity with tungsten and the like which comprises the walls of the hermetically closed chamber. Therefore, the hermetically closed chamber can be kept stable.

The object is also achieved in that the material which is to be hermetically added contains one of iodine, bromine, and chlorine. These halogens increase the vapor pressure of the emitter and can increase the transport amount of the emitter within the hermetically closed chamber. Therefore, the adsorption layer in the area directly adjacent to the electrode tip of the hermetically closed chamber can be kept stable. Furthermore, the vapor pressure of the halides of the emitter is high, the emitter can be supplied from an area with a relatively low temperature which is remote from the tip area of the electrode. Thus, the total amount of emitter which can be supplied can be increased.

Furthermore, the object is achieved in that, within the hermetically closed chamber, an arrangement is provided for supporting the hermetically closed space. By an arrangement for supporting the hermetically closed space, such as an arrangement in the form of a column-like support post, in the form of a coil-like cylinder, in the form of a net-like cylinder, in the form of a sponge or the like, it is possible to prevent the electrode tip from reaching a high temperature and the hermetically closed chamber from being deformed by operation over a long time. Thus, the hermetically closed chamber can be maintained at a constant shape, and therefore, the feed amount of the emitter can be kept constant. The building material can be a substance with the main component which is zirconium carbide, hafnium carbide, tantalum carbide which are difficult to sinter, or tungsten.

More advantageous conditions for the electrode of the invention are described below:
It is advantageous to provide an arrangement in which the hermetically closed chamber extends from directly adjacent to the electrode tip in the axial direction of the electrode, it being longer than the diameter of a cross section which is perpendicular to the axis. Because the hermetically closed chamber is longer than it is wide, a larger amount of emitter is supplied from the area which is the rear area viewed from the electrode tip. Therefore, the feed amount can be increased.
The temperature of the rear area of the electrode is lower than the tip area and is stable. The reason for this is the following:
In the vicinity of the electrode tip, the temperature gradient is roughly 1000 K/mm. A deviation in position to a small degree causes a great temperature difference, by which control of the vapor pressure by the temperature of the coolest area is difficult. The vapor pressure can be stably controlled.
It is desirable that the minimum length between the electrode tip and the inside chamber part to which the electron emission material is added be greater than or equal to 0.1 mm and less than or equal to 3.0 mm. Thus, it can be imagined that, when the minimum length between the electrode tip and the inside chamber part to which the electron emissive material is added is less than 0.1 mm, by vaporizing the metal with a high melting point, during operation, it becomes difficult to maintain the hermetically closed property. On the other hand, if the minimum length between the electrode tip and the inside chamber part which is filled with the electrode emissive material exceeds 3.0 mm, the concentration gradient of the emitter becomes small, by which the feed amount of the emitter is no longer sufficient.
It is advantageous that the metallic material with a high melting point comprising the electrode be made of a multicrystal with a S/W ratio greater than 1 where S is the size of the crystal grain in the electrode tip area in the axial direction and W is the size of the crystal in the cross-sectional direction (perpendicular to the axial direction). It can be imagined that feed of the emitter by diffusion within the metallic material with a high melting point directly underneath the electrode tip is rate-controlled. Since grain boundary diffusion takes place more rapidly than diffusion within the grain, the feed amount can be increased by facilitating grain boundary diffusion. When S/W>1, the grain boundaries which are involved in diffusion multiply. Therefore, the feed amount can be increased.
Furthermore, the metal with a high melting point between the electrode tip and the hermetically closed chamber can also be a material which is present essentially as a monocrystal. In the case of an application in which arc stability is critical, over the course of operation, the crystals grow when the metal with a high melting point which is located between the electrode tip and the hermetically closed chamber is a multicrystal, by which the diffusion paths of grain boundary diffusion diminish and by which also the feed amount decreases. Since in a monocrystal the feed amount does not fluctuate over time, stable feed can be ensured. However, since the feed amount is smaller than in a multicrystal, it is necessary to reduce the thickness of the tip, i.e., the minimum length between the electrode tip and the inside chamber part to which the electron emissive material is added.
It is desirable for the main component of the metallic material with a high melting point comprising the electrode to be tungsten. Since tungsten has a high melting point, it can be used up to a high temperature. Together with an emitter a monatomic layer for electron emission can be formed and an advantageous electron emissive property can be implemented. Furthermore, since the vapor pressure is low, electrode wear can be reduced over a long time.
It is advantageous for the main component of the substrate metal in the tip area of the electrode to be tungsten and for the substrate metal in the tip area of the electrode to contain rhenium. When the substrate metal contains rhenium, the property of electron emission is improved. Therefore, electrode wear can be reduced over a long time.
It is advantageous for the main component of the substrate metal in the tip area of the electrode to be tungsten and for the substrate metal in the tip area of the electrode to contain potassium up to 100 ppm by weight. By doping with potassium in an extremely small amount in the tip area of the electrode, the grain boundaries of the multicrystal of tungsten in the tip area can be kept stable and the diffusion paths by grain boundary diffusion can be kept stable.
It is advantageous for the tip area of the electrode to consist of a multicrystal and for the average grain size in the cross sectional direction (perpendicular to the direction of the electrode axis) of the crystal grain to be fixed at less than or equal to 100 microns. In the electrode tip area, the transport amount of the emitter by grain boundary diffusion can be increased.
An arrangement can also be undertaken in which the tip area is provided with an opening and in which there is a hermetically closed chamber with a thin wall away from the bottom of the opening. By means of the position of the partition between the bottom of the opening and the hermetically closed chamber, the temperature of the partition and the thickness of the partition can be controlled and the amount of emitter which diffuses into the interior of the partition can be kept optimum. Since the transport of the emitter from the bottom of the opening to the electrode tip takes place rapidly, diffusion within the partition becomes the determining factor. The feed amount of the emitter can be kept constant. Since the partition has a lower temperature than the tip, the deformation of the partition can be suppressed.
   Action of the Invention

According to the invention, the emitter can be supplied over a long time with an essentially constant ratio of the electrode tip and electron emission can be stably maintained over a long time, by which a stable arc can be maintained. Therefore, a light source with stable irradiance can be devised.

The invention is further described below using the drawings.

### BRIEF DESCRIPTION OF THE DRAWINGS

FIG. 1 shows a partial schematic cross section of a typical discharge lamp of the invention;

FIG. 2 shows an enlarged cross section of an electrode which is operated as a cathode;

FIG. 3 shows an enlarged cross section of an electrode which is operated as a cathode;

FIGS. 4(a) to 4(c) each show a schematic of a process for producing a hermetically closed chamber;

FIG. 5 shows a schematic which describes how the transport of an emitter is carried out for an electrode arrangement of a discharge lamp as claimed in the invention; and

FIGS. 6(a) to 6(d) each show a schematic of one example of the support arrangement within a hermetically closed chamber.

### DETAILED DESCRIPTION OF THE INVENTION

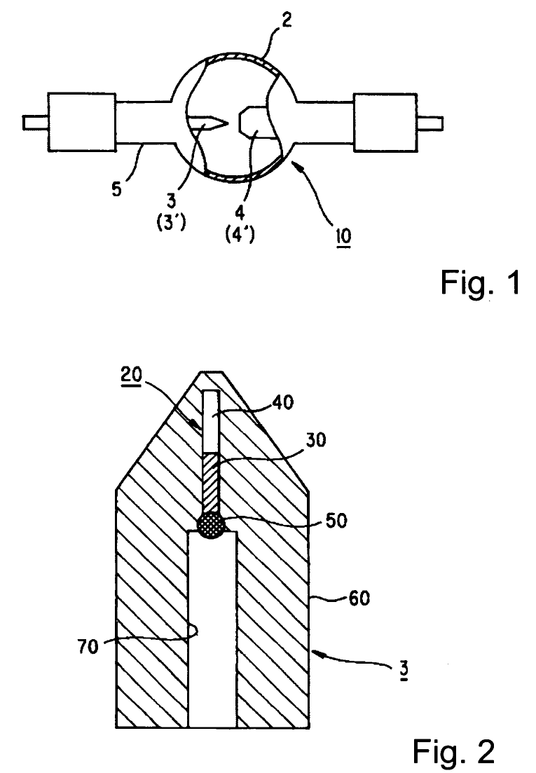

FIG. 1 schematically shows a typical discharge lamp 10 in accordance with the invention having a translucent vessel 2 which is hermetically closed, and in which there is a pair of opposed electrodes, specifically a cathode 3 and an anode 4. In the discharge lamp 10, the electrodes 3, 4 are electrically connected to the outside via sealing parts 5 on the translucent vessel 2 which are hermetically sealed. FIG. 2 is an enlargement of one electrode. The electrode which is operated as the cathode electrode 3 has a hermetically closed chamber 20 within the metal substrate 60 which has a high melting point and chamber 20 is filled with an emitter 30. Within the hermetically closed chamber 20, there is an empty space 40 which is not filled with the emitter 30. In the hermetically closed chamber, there is a vacuum or it is filled with an extremely small amount of a rare gas. The hermetically sealed enclosure 50 is produced, for example, by laser welding. The upholding part of the electrode (not shown) which supports the electrode is inserted into an opening 70 for the upholding part of the electrode.

The emitter is chosen from the materials scandium, yttrium, lanthanum, cerium, gadolinium, barium and thorium.

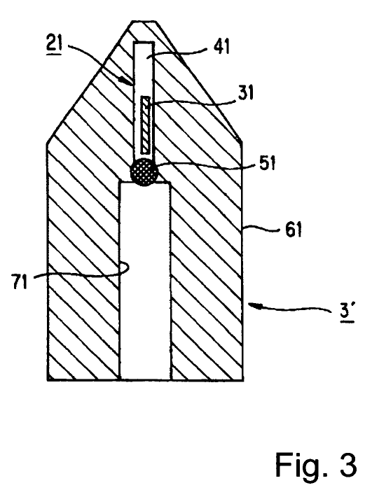

Alternatively, a discharge lamp with the same arrangement as in FIG. 1 can have a hermetically closed translucent vessel 2 in which a pair of opposed electrodes, specifically a cathode 3′ and an anode 4′, are electrically connected via sealing parts 5 which are hermetically sealed on the translucent vessel 2. In this discharge lamp, the electrode which is operated as the cathode, the electrode 3′, is formed of a substrate 61 that is made of a metal with a high melting point which contains an emitter (FIG. 3).

FIG. 3 shows an enlarged view of the electrode, within which there is a hermetically sealed chamber 21. An inductive material which induces the emitter from this substrate 61 is added to the hermetically closed chamber 21. Within the hermetically closed chamber 21, there is a space 41 which is not filled with the inductive material 31. A hermetically sealed part 51 is produced, for example, by laser welding. The upholding part of the electrode (not shown) which supports the electrode is inserted into the opening 71.

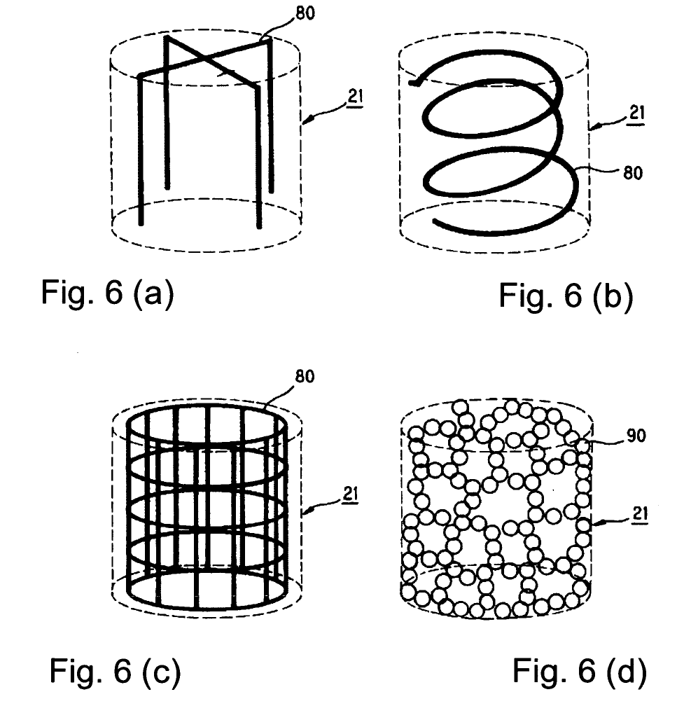

As an inductive material, an element is chosen which is selected from calcium, magnesium, strontium, zirconium, haffium and carbon. There are also cases in which the material which is to be added to the hermetically closed chamber 21 contains iodine, bromine or chlorine. Furthermore, an arrangement for supporting the hermetically closed space within the hermetically closed chamber 21 is shown by way of example using FIGS. 6(a) to 6(d). The following can be done.

Specifically an arrangement for supporting the hermetically closed chamber 21 can be undertaken as follows:

A support post of non-sag tungsten wire 80 which easily withstands deformation is produced, as is shown in FIG. 6(a);
A coil of non-sag tungsten wire 80 is produced, as is shown in FIG. 6(b);
A net-like cylinder of non-sag tungsten wire 80 is produced, as is shown in FIG. 6(c).

Furthermore, as shown in FIG. 6(d), there can also be a sponge-like, air-permeable sintered compact 90 of zirconium carbide as the support body. The main component of the substrate metal in the tip area of the electrode is tungsten. The substrate metal in the tip area of the electrode contains an emitter.

A process for producing the hermetically closed chamber is described schematically below.

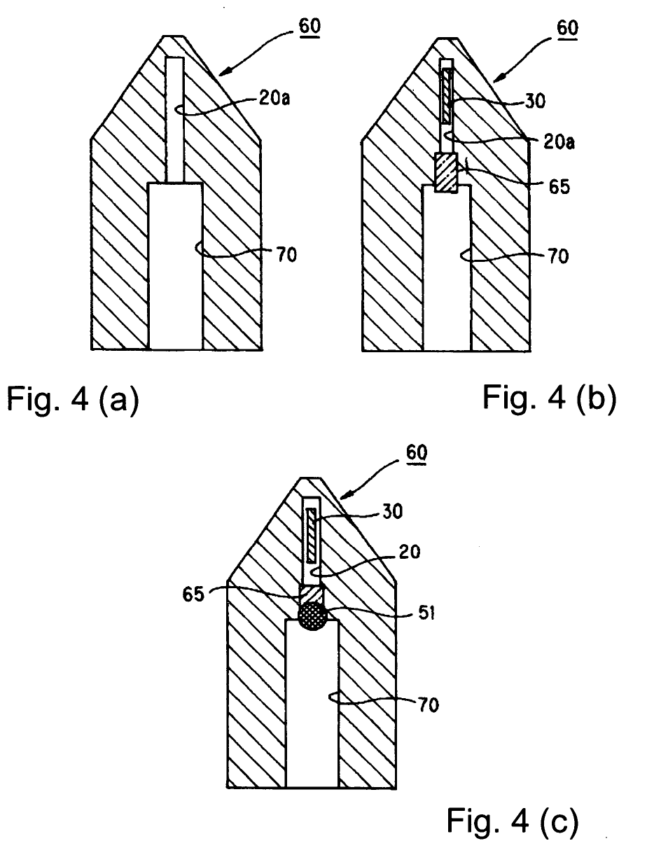

FIGS. 4(a) to 4(c) each show the steps of the process for producing the hermetically closed chamber. FIG. 4(a) shows the step of machining. The tip of a cylindrical metal substrate 60 with a high melting point is subjected to conical processing. From the side which is opposite the conically-shaped side, an opening 70 for the upholding part of the electrode and an opening 20a which borders it for a hermetically closed chamber are subjected to opening processing, which comprises, for example, electrical discharge machining. For the opening 20a for the hermetically closed chamber drilling is done into the vicinity of the electrode tip. There is a demand for uniformity of the surface precision on the bottom in the vicinity of the electrode tip of the hermetically closed chamber in order to ensure uniformity of diffusion of the emitter.

FIG. 4(b) shows the step of fill processing of the emitter. The opening 20a for the hermetically closed chamber is filled with the emitter 30. The opening part of the opening 20a for the hermetically closed chamber 20 is plugged with a temporary plug 65 of a metal with a high melting point.

FIG. 4(c) shows the step of hermetic enclosure by means of a laser. From the open side of the opening 70 for the upholding part of the electrode, laser irradiation is performed, the temporary plug 65 is melted, and thus, hermetic enclosure is achieved. FIG. 4(c) shows the not yet closed state in which the temporary plug 65 still remains.

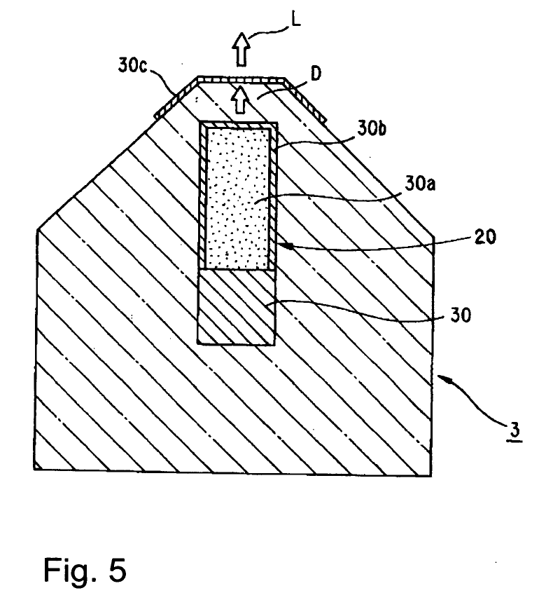

FIG. 5 is a schematic which describes how transport of the emitter in the electrode arrangement of a discharge lamp in accordance with the invention is carried out. It can be imagined that transport of the emitter takes place as follows:
(1) Part of the emitter 30 within the hermetically closed chamber 20 in the cathode 3 is vaporized and becomes the vapor 30a of the emitter.
(2) The inside surface of the hermetically closed chamber 20 adsorbs the vapor 30a of the emitter and forms an adsorption layer 30b which is located in the hermetically closed chamber.
(3) From the adsorption layer 30b which is located in the hermetically closed chamber directly underneath the electrode tip, in the direction toward the electrode tip, the emitter 30 is transported by diffusion in the solid (D in the drawings). The concentration gradient of the emitter 30 is constant. The transport rate of the emitter 30 is therefore also constant.
(4) The emitter which has been transported by diffusion in the solid yields a monatomic layer 30c of the emitter. By reducing the work function advantageous electron emission takes place.
(5) Since the monatomic layer 30c of the emitter has a high temperature, it gradually vaporizes and is used up (L in the drawings).

Specific embodiments of the invention are described below.

### Embodiment 1

The overall shape of the lamp corresponds to FIG. 1. FIG. 2, as has been essentially described above, is an enlarged cross-section of the electrode which is operated as a cathode. A rod-like tungsten material with a diameter of 15 mm which contains lanthanum oxide with 1% by weight was used as the substrate metal with a high melting point 60. The cathode tip was worked into the shape of a truncated cone with a tip diameter of 1.2 mm and a tip angle of 80 degrees. At the point which is 1.0 mm away from the tip, there is a hermetically closed chamber 20 with a diameter of 1.0 mm and a length of 8 mm which extends down from directly underneath the tip along the lengthwise axis of the electrode. The hermetically closed chamber 20 was filled with an about 5.0 mg piece of lanthanum as the emitter 30. Enclosure was achieved by a temporary tungsten plug (not shown) which was irradiated from behind with YAG laser light and part of it was melted.

Using the above described cathode, a super-high pressure mercury lamp with a lamp input wattage of 4.3 kW and a distance between the electrodes of 5.0 mm was produced. The stability of the arc was evaluated using the fluctuation f (%) of the voltage. The fluctuation of the voltage f (%) is defined after operation of at least 30 minutes and after thermal stabilization by the following formula where the maximum value of the lamp voltage which is applied for one minute is designated Vmax and its minimum value is designated Vmin:
f=(Vmax−Vmin)/Vmax)×100 (%)

The fluctuation f at the start is 1% to 2%. When the arc becomes unstable, the fluctuation f exceeds 3%. The voltage fluctuation monitors and assesses as arc instability when the fluctuation f has exceeded 3%.

In a lamp with the same shape, using a conventional cathode for which tungsten which contains 2% thorium oxide, arc instability occurred during an interval between 800 and 1200 hours. The expression “conventional cathode” is defined as a cathode in which 2% thorium oxide is uniformly incorporated into the cathode. The lamp of the invention was evaluated and it was found that the arc was stable up to 1500 hours. Furthermore, the shape of the arc spot was visually observed. No instability phenomenon, such as arc fluctuation or the like, was observed. In this example, direct current was used and the electrode was the cathode. The electrode of the invention is however not limited thereto, and the anode could be used as the electrode. Therefore, it goes without saying that operation using an alternating current is also possible.

### Embodiment 2

The overall shape of the lamp corresponds to FIG. 1. The substrate metal with a high melting point 60 of the electrode which is operated as a cathode in FIG. 2 was a rod-shaped tungsten material with a diameter of 12 mm which contains lanthanum oxide with 1% by weight. The cathode tip was machined into the shape of a truncated cone with a tip diameter of 1.2 mm and a tip angle of 60 degrees. At a point which is 1.5 mm away from the tip, there is a hermetically closed chamber 20 with a diameter of 0.8 mm and a length of 20 mm which extends down from directly underneath the tip along the lengthwise axis of the electrode. The hermetically closed chamber 20 was filled with 2.0 mg lanthanum iodide as the emitter. Using the above described cathode, a super-high pressure mercury lamp with a lamp input wattage of 4.3 kW and a distance between the electrodes of 5.2 mm was produced.

In a lamp with the same shape using a conventional cathode for which tungsten which contains 2% thorium oxide, arc instability occurred during an interval between 800 and 1200 hours. The lamp of the invention was evaluated and it was found that the arc was stable up to 1500 hours. Furthermore, the shape of the arc spot was visually observed. No instability phenomenon, such as arc fluctuation or the like, was observed.

### Embodiment 3

The overall shape of the lamp corresponds to FIG. 1. The substrate metal with a high melting point 60 of the electrode which is operated as a cathode in FIG. 2 was a rod-shaped tungsten material with a diameter of 10 mm which contains cerium oxide with 1% by weight. The cathode tip was machined into the shape of a truncated cone with a tip diameter of 1.0 mm and a tip angle of 45 degrees. At a point 0.5 mm away from the tip there is a hermetically closed chamber 20 with a diameter of 0.6 mm and a length of 8 mm which extends down from directly underneath the tip along the electrode axis. The hermetically closed chamber 20 was filled with a roughly 5.0 mg piece of yttrium as the emitter. Using the above described cathode a super-high pressure mercury lamp with a lamp input wattage of 2.5 kW and a distance between the electrodes of 4.7 mm was produced.

In a lamp with the same shape using a conventional cathode for which tungsten which contains 2% thorium oxide, arc instability occurred during an interval between 1500 hours and 2000 hours. The lamp in accordance with the invention was evaluated and it was found that the arc was stable up to 2000 hours. Furthermore, the shape of the arc spot was visually observed. No instability phenomenon, such as arc fluctuation or the like. was observed.

### Embodiment 4

The overall shape of the lamp corresponds to FIG. 1. The substrate metal with a high melting point of the electrode which is operated as a cathode in FIG. 2 was a rod-shaped tungsten material with a diameter of 10 mm which has a purity of at least 99.9%. The cathode tip was machined into the shape of a truncated cone with a tip diameter of 1.0 mm and a tip angle of 45 degrees. At a point which is 0.5 mm away from the tip, there is a hermetically closed chamber 20 with a diameter of 0.6 mm and a length of 10 mm which extends down from directly underneath the tip along the lengthwise axis of the electrode. The hermetically closed chamber 20 was filled with a roughly 5.0 mg piece of lanthanum as the emitter. Furthermore, for diffusion at 2400° C., heat treatment and thus diffusion of the emitter in a vacuum was performed for 24 hours. Using the above described cathode, a super-high pressure mercury lamp with a lamp input of 2.5 kW and a distance between the electrodes of 4.7 mm was produced.

In a lamp with the same shape using a conventional cathode for which tungsten which contains 2% thorium oxide, arc instability occurred during an interval between 1500 and 2000 hours. The lamp of the invention was evaluated and it was found that the arc was stable up to 2000 hours. Furthermore, the shape of the arc spot was visually observed. No instability phenomenon, such as arc fluctuation or the like, was observed.

### Embodiment 5

The overall shape of the lamp corresponds to FIG. 1. The substrate metal with a high melting point 61 of the electrode which is operated as a cathode in FIG. 3 was a rod-shaped tungsten material with a diameter of 8 mm which contains yttrium oxide with 2% by weight. The cathode tip was machined into the shape of a truncated cone with a tip diameter of 0.8 mm and a tip angle of 40 degrees. At the point which is 1.5 mm away from the tip there is a hermetically closed chamber 21 with a diameter of 1.0 mm and a length of 10 mm which extends down from directly underneath the tip along the lengthwise axis of the electrode. The hermetically closed chamber 20 was filled with 2.0 mg calcium as the material which induces the emitter. Using the above described cathode a super-high pressure mercury lamp with a lamp input wattage of 2.0 kW and a distance between the electrodes of 4.4 mm was produced.

In a lamp with the same shape using a conventional cathode for which tungsten which contains 2% thorium oxide was used, arc instability occurred during an interval between 800 hours and 1200 hours. The lamp according to the invention was evaluated and it was found that the arc was stable up to 1500 hours. Furthermore, the shape of the arc spot was visually observed. No instability phenomenon, such as arc fluctuation or the like, was observed.

### Embodiment 6

The overall shape of the lamp corresponds to FIG. 1. The substrate metal with a high melting point 61 of the electrode which is operated as a cathode in FIG. 3 was a rod-shaped tungsten material with a diameter of 20 mm which contains yttrium oxide with 2% by weight. The cathode tip was machined into the shape of a truncated cone with a tip diameter of 1.8 mm and a tip angle of 60 degrees. At a point which is 1.0 mm away from the tip, there is a hermetically closed chamber 21 with a diameter of 1.2 mm and a length of 8 mm which extends down from directly underneath the tip along the lengthwise axis of the electrode. To introduce carbon as the material which induces the emitter into the hermetically closed chamber 21, a tungsten rod with a diameter of 0.8 mm and a length of 4.0 mm with an approximately 30 micron thick carbon layer on its surface was added. Using the above described cathode, a super-high pressure mercury lamp with a lamp input wattage of 8.0 kW and a distance between the electrodes of 7.2 mm was produced.

In a lamp with the same shape using a conventional cathode for which tungsten which contains 2% thorium oxide, arc instability occurred during an interval between 800 hours and 1000 hours. The lamp of the invention was evaluated and it was found that the arc was stable up to 1000 hours. Furthermore, the shape of the arc spot was visually observed. No instability phenomenon, such as arc fluctuation or the like, was observed.

### Embodiment 7

The overall shape of the lamp corresponds to FIG. 1. The substrate metal with a high melting point 61 of the electrode which is operated as a cathode in FIG. 3 was a rod-shaped tungsten material with a diameter of 12 mm which contains yttrium oxide with 2% by weight. The cathode tip was machined into the shape of a truncated cone with a tip diameter of 1.8 mm and a tip angle of 50 degrees. At a point which is 2.5 mm away from the tip, there is a hermetically closed chamber 21 with a diameter of 1.2 mm and a length of 20 mm which extends down from directly underneath the tip along the electrode axis. The hermetically closed chamber 21 was filled with 2.0 mg magnesium bromide as the material which induces the emitter. Using the above described cathode a super-high pressure mercury lamp with a lamp input wattage of 4.5 kW and a distance between the electrodes of 6.2 mm was produced.

In a lamp with the same shape using a conventional cathode for which tungsten which contains 2% thorium oxide, arc instability occurred during an interval between 750 hours and 900 hours. The lamp according to the invention was evaluated and it was found that the arc was stable up to 1000 hours. Furthermore, the shape of the arc spot was visually observed. No instability phenomenon, such as arc fluctuation or the like was observed.

1. Discharge lamp, comprising a translucent vessel which is hermetically sealed and in which there is a pair of opposed electrodes, and in which the electrodes are electrically connected via hermetically sealed areas on the translucent vessel, wherein at least one of the electrodes is formed of a substrate of a metal with a high melting point in which a hermetically sealed chamber is provided, an emitter being located in part of said chamber leaving a space which is not filled by the emitter.

2. Discharge lamp as claimed in claim 1, wherein the emitter contains an element which is selected from the group consisting of scandium, yttrium, lanthanum, cerium, gadolinium, barium and thorium.

3. Discharge lamp as claimed in claim 1, wherein the main component of the substrate metal in the tip area of the electrode is tungsten and wherein the substrate metal in the tip area of the above described electrode contains an emitter.

4. Discharge lamp as claimed in claim 1, wherein the material in the hermetically sealed chamber comprises at least one from the group consisting of iodine, bromine, and chlorine.

5. Discharge lamp which has a translucent vessel which is hermetically closed and in which there is a pair of opposed electrodes, and in which the electrodes are electrically connected via hermetically sealed areas on the translucent vessel, wherein at least one of the electrodes is made of a substrate of a high melting point metal which contains an emitter, wherein an inductive material which induces the emitter from the substrate is contained in a portion of a hermetically sealed chamber within said substrate with part of the chamber not being filled with the inductive material.

6. Discharge lamp as claimed in claim 5, wherein the inductive material within the hermetically sealed chamber contains an element which is selected from the group consisting of calcium, magnesium, strontium, zirconium, hafnium and carbon.

7. Discharge lamp as claimed in claim 1, wherein the wall of the chamber adjacent to the electrode tip has a distance from the electrode tip which is in the range from 0.1 to 3.0 mm.

8. Discharge lamp as claimed in claim 1, wherein the chamber is longer in a lengthwise axial direction of the electrode than in a direction perpendicular to the lengthwise axis of the electrode.

9. Discharge lamp as claimed in claim 1, wherein the lamp is adapted to be operated in an orientation in which the electrodes are arranged essentially vertically one on top of the other.

10. Discharge lamp as claimed in claim 1, wherein the metal substrate of the electrode, in the area of the electrode tip, has a crystal grain structure with crystal grains that have a length in a lengthwise axial direction of the electrode which is greater than their width perpendicular to the lengthwise axial direction of the electrode.

11. Discharge lamp as claimed in claim 10, wherein the width of the crystal grains is at most 100 microns.

12. Discharge lamp as claimed in claim 1, wherein the metal substrate of the electrode consists of tungsten.
